(19) United States
(12) Patent Application Publication
(10) Pub. No.: US 2011/0093434 A1
(43) Pub. Date: Apr. 21, 2011

(54) METHOD AND SYSTEM FOR SEARCHING DOCUMENTS IN LOCAL AREA NETWORK

(75) Inventors: Manish ARORA, Delhi (IN); Bhavik JANI, Ahmedabad (IN); Deepak RUSTAGI, Delhi (IN); Monu AUL, Bangalore (IN)

(73) Assignee: INFOSYS TECHNOLOGIES LIMITED, Bangalore (IN)

(21) Appl. No.: 12/784,568

(22) Filed: May 21, 2010

(30) Foreign Application Priority Data
Oct. 16, 2009 (IN) 2519/CHE/2009

(51) Int. Cl. G06F 17/30

(52) U.S. Cl. 707/622; 707/706; 707/769; 707/E17.108; 707/E17.005; 707/740; 707/E17.09; 707/711; 707/E17.002

(57) ABSTRACT

A method and system for searching one or more documents in a Local Area Network (LAN) is provided. The system includes a synchronization module, a link module, and a search engine. The synchronization module automatically synchronizes multiple knowledge sources, such as one or more pre-defined databases, one or more software version control system (SVCS) databases, and so forth, with a server at various pre-defined intervals of time. The link module connects at least one user with the server in response to a request received from the user. Once the user is connected with the server, the link module receives a search query from the user and forwards it to the search engine. The search engine then identifies one or more results in the synchronized documents and provides search results to the link module. The link module then displays the results to the user.

### BACKGROUND

The invention relates generally to the field of managing information in an organization. More specifically, the invention relates to a method and system for enabling users to search documents in a Local Area Network (LAN) of the organization.

There are various types of information in an organization which needs to be managed by its employees to enhance their learning and expertise. The learning and expertise is typically developed through the experience gained while dealing with various circumstances during the course of a project. However, a large portion of knowledge remains untapped in many organizations due to information silos. These information silos exist because of remote offices, multiple lines of business, large workforce, etc. Occasionally, information or learning gained by a user from a project is captured, however, the organization fails to store the information in a standard format common to all its employees. Furthermore, an individual shares information or knowledge with other team members and clients through emails on a regular basis. For example, the individual shares his findings, research papers, other attachments, and the like. However, this information is always restricted to the individual's inbox or to the team, and thus fails to reach the other employees.

The organization usually has multiple databases in its LAN. There may be various folders that are designated as ‘shared’ and the individuals/employees of the organization store knowledge documents in these shared folders. Various examples of the documents include, but are not limited to, MS Word® documents, MS Excel® documents, PDFs, and the like. However, such a repository is limited to a team or an individual, and may not be accessible by other teams in the organization. Furthermore, in industries, for example, information technology, software developers maintain knowledge related to software codes associated with various projects. However, the software codes may not be accessible to other users or other teams within the organization.

Currently, organizations use various tools for knowledge management, but such tools have various limitations, for example, no option to store emails, improper formats, cumbersome tagging of the documents, etc. In addition to these limitations, individuals perform key words-based searches to identify desired files in the shared folders. The results of these searches are provided by matching file names with the key words. Thus, such searches fail to identify documents on the basis of their content and may provide irrelevant results. Thereafter, the individuals may need to manually analyze the content of the documents to find the desired documents.

In light of the foregoing discussion, there is a need for a method and system that collates various documents that are shared across the organization to one common repository. Further, there is a need for a methodology that enables users to store information sources such as emails in the common repository. Furthermore, there is a need for searches based on the content of documents, to provide accurate results to search queries entered by the users.

### SUMMARY

The invention provides a method, system and computer program product for searching one or more documents in a Local Area Network (LAN) of an organization. The system includes a synchronization module, a link module, and a search engine. The synchronization module automatically synchronizes one or more pre-defined databases of a LAN with a server at first pre-defined intervals of time. The pre-defined databases include a first set of documents, such as emails, important presentations, documents, meeting requests, and the like, which are stored by various users or individuals of the organization. Similarly, the synchronization module automatically synchronizes one or more software version control system (SVCS) databases with the server at second pre-defined intervals of time. The SVCS databases include a second set of documents such as various versions of software codes.

The link module connects at least one of one or more users with the server in response to a request sent by the user. After receiving the request sent by the user, the link module receives a search query from the user. Thereafter, the link module forwards the search query to the search engine. The search engine processes the search query against the synchronized documents based on the content of the documents and identifies one or more documents that are related to the search query. Subsequently, the search engine forwards the search results to the link module to display them to the user.

The system described above has several advantages. The system enables collation of various types of documents in the organization to a common repository. The system also saves knowledge information such as emails and their corresponding attachments, in the common repository. Further, the system enables the users in the organization to perform a content-based search on the stored documents. Thus, the method enables the users to share and retrieve information in the organization in an efficient manner.

### BRIEF DESCRIPTION OF THE DRAWINGS

Various embodiments of the invention will hereinafter be described in conjunction with the appended drawings, provided to illustrate and not to limit the invention, wherein like designations denote like elements, and in which:

FIG. 1 illustrates an environment in which various embodiments of the invention can be practiced;

FIG. 2 is a block diagram of a system for searching one or more documents in a Local Area Network (LAN), in accordance with an embodiment of the invention;

FIG. 3 is a flowchart representing a method for searching one or more documents in the LAN, in accordance with an embodiment of the invention; and

FIG. 4 is a flowchart representing a method for storing one or more documents such as emails from a mailbox to a pre-defined database/server, in accordance with an embodiment of the invention.

### DETAILED DESCRIPTION OF DRAWINGS

The invention provides a method and system for searching one or more documents in a Local Area Network (LAN). The system includes a synchronization module, a link module, and a search engine. The synchronization module automatically synchronizes multiple knowledge sources, such as one or more pre-defined databases, one or more software version control system (SVCS) databases, and so forth, with a common knowledge repository, such as a server, at various pre-defined intervals of time. The link module connects at least one user with the server in response to a request received from the user. Once the user is connected with the server, the link module receives a search query from the user and forwards the search query to the search engine. The search engine then searches for one or more synchronized documents on the server and provides at least one message and one or more results to the link module. The link module subsequently displays the message and the results to the user.

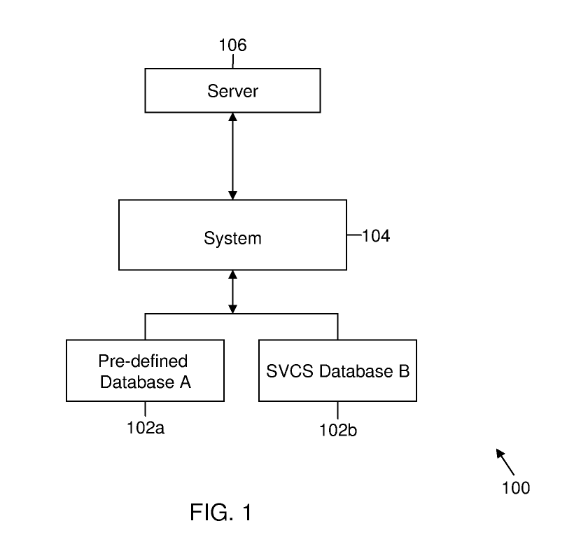

FIG. 1 illustrates an environment 100 in which various embodiments of the invention can be practiced. Environment 100 includes one or more pre-defined databases such as a pre-defined database 102a, and one or more software version control system (SVCS) databases such as a SVCS database 102b, a system 104, and a common knowledge repository such as a server 106.

All individuals in an organization come across a large amount and various types of information on a regular basis. To share their experience and knowledge with other members of the organization, the individuals/users save various documents, such as a first set of documents, in one or more pre-defined databases in a Local Area Network (LAN), such as pre-defined database 102a. Various examples of the first set of documents include, but are not limited to, project-related emails, MS Word® documents, MS Excel® documents, PowerPoint® presentations, training manuals, training videos, project manuals, PDFs, text documents, and the like. In various embodiments of the invention, pre-defined database 102a may be defined by a system administrator of the LAN.

In addition to the first set of documents saved by the users, a large amount of knowledge is also present in SVCS databases, such as SVCS database 102b, that act as a repository of various documents related to the versions of a software code, hereinafter referred to as a second set of documents. It is well known in the art that the software code undergoes a number of changes at various stages and multiple versions of the software code may be generated at each stage. Each version of the software code is accordingly stored in SVCS database 102b. In addition to storing software codes, SVCS database 102b also stores other files such as, MS Word® documents, MS Excel® documents, PDFs, and the like. Examples of SVCS include, but are not limited to Microsoft® Visual SourceSafe, IBM® ClearCase, AccuRev, Vault, and the like.

System 104 synchronizes the first set of documents and the second set of documents stored in pre-defined database 102a and SVCS database 102b with server 106. In an embodiment of the invention, the system administrator may configure the synchronization frequency of system 104 to synchronize pre-defined database 102a and SVCS database 104b with server 106 at the pre-defined time intervals, for example, one hour, twelve hours, daily, and so forth. In another embodiment of the invention, the first set of documents may be synchronized at first pre-defined intervals of time and the second set of documents may be synchronized at second pre-defined intervals of time. The first the second pre-defined intervals of time may be defined by the system administrator.

System 104 then connects at least one user of the users with server 106 in response to a request received from the at least one user. In an embodiment of the invention, the request may be in the form of an IP address entered by the user in an Internet browser. The IP address may be pre-defined by the system administrator.

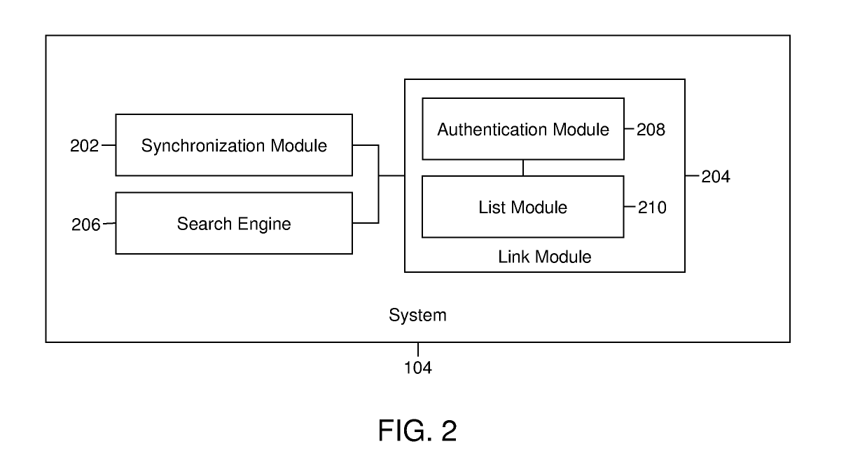

Once the user is connected with server 106, system 104 receives a search query from the user. Thereafter, system 104 processes the search query against the synchronized documents stored on server 106 and displays at least one of a message or one or more results related to the search query. For example, a search query such as ‘coding mechanisms’ entered by the user may show zero results, and accordingly a message may be displayed to the user. Further, the search result for a search query such as ‘training programs on estimation techniques’ may be displayed as 100 results found. Accordingly, system 104 may display the results in the form of hyperlinks to enable the user to easily access the results. System 104 is explained in detail in conjunction with FIG. 2.

FIG. 2 is a block diagram of system 104 for searching one or more documents in a Local Area Network (LAN), in accordance with an embodiment of the invention. System 104 includes a synchronization module 202, a link module 204, and a search engine 206. Link module 204 includes an authentication module 208 and a list module 210.

Synchronization module 202 automatically synchronizes pre-defined database 102a and SVCS database 102b with server 106. Embodiments explaining the synchronization of such databases with server 106 have been explained in conjunction with FIG. 1. In various embodiments of the invention, synchronization module 202 synchronizes the first set of documents and the second set of documents from pre-defined locations on pre-defined database 102a and SVCS database 102b. The pre-defined locations may be defined by a system administrator.

Synchronization module 202 synchronizes the first set of documents and the second set of documents based on one or more pre-defined authentication details. The pre-defined authentication details may be set by the system administrator to enable secure synchronization of the first set of documents and the second set of documents with server 106. This enables secure transfer of the documents present on pre-defined database 102a and SVCS database 102b, as the documents may be confidential and should not be accessible for synchronization to a user outside the organization. Thus, synchronization module 202 establishes a connection with pre-defined database 102a and SVCS database 102b with respective authentication details each time prior to synchronizing the first and the second set of documents.

In an embodiment of the invention, synchronization module 202 synchronizes the latest version of the second set of documents from SVCS database 102b. For example, a software developer may update a software code several times in a day. Thus, if there are multiple versions of the same software code, synchronization module 202 synchronizes only the latest version of the software code available in SVCS database 102b. In another embodiment of the invention, synchronization module 202 may delete the existing version of the software code on server 106 and replace it with the latest version of the software code. Further, synchronization module 202 directly synchronizes the latest version of the software code when the software code is being synchronized for the first time. In other words, if there is no previous version of the software code stored on server 106, synchronization module 202 replicates the first version of the software code on server 106. In another embodiment of the invention, synchronization module 202 may save the latest version of the software codes along with the previous versions of the software codes. It may be appreciated by any person skilled in the art that the latest version of the second set of documents may be identified through associated time stamps.

In an embodiment of the invention, synchronization module 202 may synchronize only a set of documents of the first set and the second set of documents based on the file extensions of the first set and the second set of documents. For example, an extension such as ‘ini’ may be excluded while synchronizing. In various embodiments of the invention, the extension of files or documents to be excluded or included for synchronizing with server 106 may be defined by the system administrator. In another embodiment of the invention, synchronization module 202 may synchronize the first set and the second set of documents based on the associated file permissions, such as ‘Private’ and ‘Public’. For example, a user may not want to share a particular document with other teams other than his/her team because of confidentiality reasons.

Synchronization module 202 may synchronize the first set of documents and the second set of documents in a batch. Furthermore, synchronization module 202 may generate error reports for the system administrator if errors occur while synchronizing the documents. In various embodiments of the invention, the synchronized documents are stored on server 106 at one or more pre-defined locations. In other words, synchronization module 202 synchronizes multiple source folders from pre-defined database 102a and SVCS database 102b with multiple destination folders located at server 106.

Link module 204 connects a user with server 106 in response to a request sent by the user. The type of request sent by the user has been explained in conjunction with FIG. 1. After receiving the request, authentication module 208 checks whether the user has the required privilege to access server 106 or not. To authenticate the user, authentication module 208 checks a pre-defined list of authorized users stored in list module 210. In various embodiments of the invention, the pre-defined list of users may be defined by the system administrator. In an embodiment of the invention, authentication module 208 may check the authenticity of the user based on the user's IP address. If the user is not authenticated, link module 204 displays a message to the user and denies access to server 106.

If the user is authenticated, link module 204 may display a web page to receive a search query from the user. Thereafter, link module 204 forwards the search query to search engine 206. In an embodiment of the invention, link module 204 converts the format of the search query received from the user into a required format which is executable by search engine 206. Thereafter, search engine 206 searches server 106 based on the search query to identify one or more results. Then, link module 204 receives one or more results based on the search query from search engine 206. Subsequently, link module 204 parses the search results and displays them along with hyperlinks to the user. In another embodiment of the invention, some of the features of search engine 206 are disabled by link module 204 for security purposes.

Similarly, link module 204 provides a common platform to all the users of the organization, receives search queries from them, and converts the search queries in the format executable by search engine 206. Thereafter, link module 204 receives results related to each search query from search engine 206 and displays the search results along with hyperlinks to the corresponding users.

In an embodiment of the invention, link module 204 may be a website or a web page that acts as a ‘Mask Website’ for search engine 206. The ‘Mask Website’ receives the request and the search query from the user and then converts the search query in a format that is executable by search engine 206. Thereafter, ‘Mask Website’ receives the results related to the search query from search engine 206 and displays the search results to the user. In an embodiment of the invention, search engine 206 may be the Google Desktop Search™ tool.

Search engine 206 indexes the first and the second set of documents based on the content. It may be appreciated by any person skilled in the art that content-based indexing of the documents helps in searching the documents in a fast, effective and efficient manner. In various embodiments of the invention, system 104 is installed on server 106. Thus, synchronization module 202, link module 204, and search engine 206 are installed on server 106. In various embodiments of the invention, the modules of system 104, such as synchronization module 202, link module 204, search engine 206, authentication module 208, and list module 210, may be implemented in the form of software, hardware, firmware, or combinations thereof.

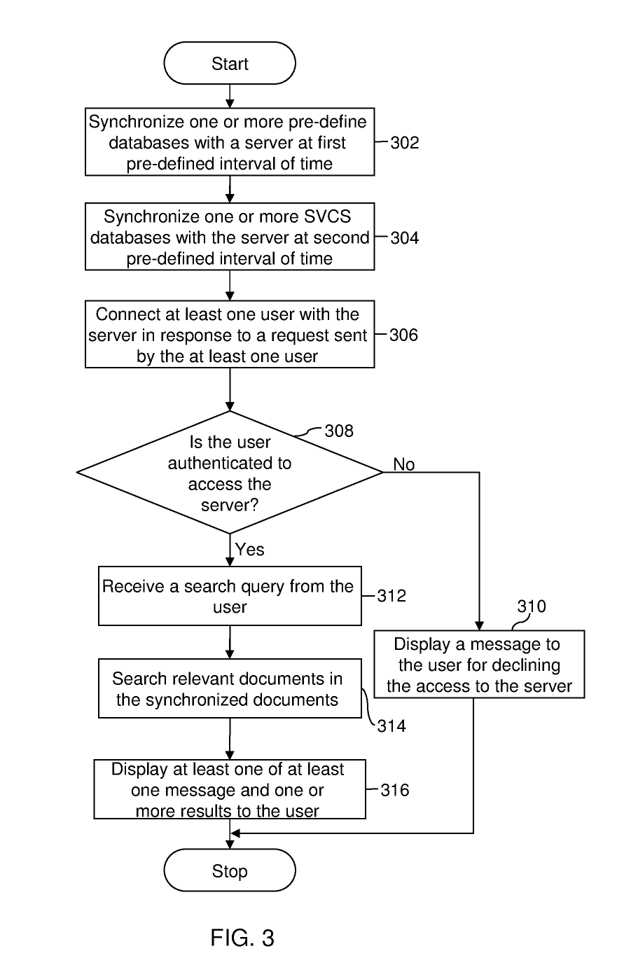

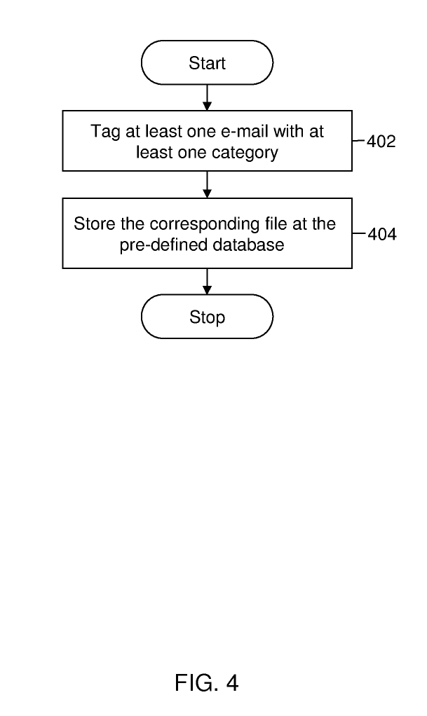

FIG. 3 is a flowchart representing a method for searching documents in the LAN, in accordance with an embodiment of the invention. At 302, one or more pre-defined databases in the LAN, for example, a pre-defined database such as pre-defined database 102a, are synchronized with a server such as server 106 at first pre-defined intervals of time. The pre-defined database includes a first set of documents containing knowledge articles, such as project-related emails, forums, project manuals, training manuals, screen shots in the form of images, PDF files, MS Word® files, MS Excel® files, text files, and the like, which are stored by various individuals/users of an organization. Further, a method to enable a user to save the emails form his or her inbox to the pre-defined database is explained in detail in conjunction with FIG. 4.

At 304, one or more software version control system (SVCS) databases, for example, a SVCS database such as SVCS database 102b, are synchronized with the server at second pre-defined intervals of time. The SVCS database includes a second set of documents. The second set of documents is various versions of a software code. It is well known in the art that the software code undergoes multiple changes during various stages and multiple versions of the software code may be generated at each stage. Thus, each version of the software code is accordingly stored in the SVCS database. Various examples of software version control system include, but are not limited to, Microsoft Virtual Source Safe, and the like.

In an embodiment of the invention, the latest version of the software code may be synchronized with the server. Further, an old version of the software code, if available on the server, may be replaced with the latest version while synchronizing. In another embodiment of the invention, the old version and the latest version may be maintained simultaneously on the server. Further, a set of documents from the first set and the second set of documents may be synchronized based on the associated file extensions. The file extensions to included or excluded during synchronization may be defined by a system administrator.

At 306, a user is connected with the server in response to a request received from the user. The request may be an IP address entered by the user in an Internet browser to establish a connection with the server. Thereafter, the user is connected with the server, at 308, it is checked if the user is authenticated to access the server. If, at 308, it is determined that the user is not authenticated to access the server, then, at 310 the user is denied access to the server. The user may be authenticated on the basis of a pre-defined list of users stored on the server. In various embodiments of the invention, the pre-defined list of the users may be stored by the system administrator.

However, if, at 308, it is determined that the user is authenticated to access the server, then, at 312, a search query is received from the user. In an embodiment of the invention, the search query is forwarded to a search engine, such as search engine 206, installed on the server. The search query sent by the user is converted to a format which is executable by the search engine. At 314, one or more synchronized documents on the server are searched based on the search query. For example, if the search query is ‘project guidelines’, then the synchronized documents are accordingly searched to identify one or more results. Thereafter, at 316, the results related to the search query are displayed to the user. In an embodiment of the invention, the results may be displayed along with their hyperlinks. Similarly, various users in the organization perform searches on the server to obtain results related to their respective search queries.

In an embodiment of the invention, the search engine may be Google Desktop Search™. In an embodiment of the invention, the synchronized documents are indexed based on their content. It may be appreciated by any person skilled in the art that content-based indexing increases the accuracy of the results and saves time.

FIG. 4 is a flowchart representing a method for storing one or more first set of documents such as emails from a mailbox to the pre-defined database/server, in accordance with an embodiment of the invention.

Emails exchanged between individuals working on a particular project may include a large amount of project-related information. To utilize and share the content present in the emails, it is required to transfer the emails, associated attachments, meeting requests, appointments, and the like, from the mailbox of each member of the team to the pre-defined database. Thereafter, the emails and the attachments can be synchronized with the server and made available for searching to other individuals/users in the organization. Various examples of a mailbox may include, but are not limited to, Microsoft Outlook®, Lotus Notes®, and so forth.

At 402, a user tags at least one email from the one or more emails in his or her inbox with at least one category of the pre-defined categories. Various examples of the one or more pre-defined categories include, but are not limited to, Microsoft®, Java®, COBOL®, .Net® and so forth. In another embodiment of the invention, the system administrator or the user may define the pre-defined categories.

Subsequently, at 404, the email tagged by the user is saved in the pre-defined database. In an embodiment of the invention, the tagged emails are stored at one or more pre-defined locations in the pre-defined database. For example, emails related to ‘COBOL’ technology may be stored in a folder named ‘COBOL’ in the pre-defined database. These pre-defined locations may be defined by the system administrator.

In another embodiment of the invention, a templatization mechanism may be used to define a standard which may need to be maintained by the team members while submitting the knowledge information through emails. This may enable the members to analyze and communicate knowledge in a particular template while maintaining the uniformity of the stored information. For example, the ‘signatures’ feature from Microsoft Outlook can be used to define a template.

In various embodiments of the invention, the emails/appointments/meeting requests are converted to a pre-defined format when they are stored on the pre-defined database. For example, if the email selected by the user is in HTML format, it is saved as an HTML file. Similarly, if the email is in a plain text format, it is stored as a text file. Similarly, the associated attachments are also stored in the corresponding formats in the pre-defined database. Further, the hyperlinks of the attachments are added in the corresponding saved emails. In addition to adding hyperlinks to the attachments in the email, the name of the user who has saved it may also be added in the corresponding emails. This helps the other users in contacting the user who has saved the email in the pre-defined database. In an embodiment of the invention, the status of the progress of saving the email in the pre-defined database is also provided to the user.

It may be appreciated by any person skilled in the art that the emails/attachments/appointments/meeting requests are synchronized with the server, and thus are searchable by multiple users in the LAN. In another embodiment of the invention, the emails can be stored directly on the server. In an exemplary embodiment of the invention, the users may not tag the emails with one or more pre-defined categories. In such a case, the corresponding file of the selected email is transferred to a common folder located in the pre-defined database. In other words, the user may choose to transfer the email to the pre-defined database without tagging it with a pre-defined category.

In an embodiment of the invention, a plug-in is provided for the mailbox to enable the user to tag and store the emails in the pre-defined database/server. The plug-in may be installed by the user. Thereafter, the plug-in gets embedded in the mailbox and can be used by the server to transfer the emails to the pre-defined database.

The method, system and computer program product described above have several advantages. The method and system enables collation of various types of documents in an organization to a common repository. The method also enables the users to save knowledge information present in their emails along with their attachments to the common repository. Further, the system enables the users in the organization to perform a content-based search on the stored documents. Thus, the method enables the users to share and retrieve information within the organization in an efficient manner.

The system for searching one or more documents in a Local Area Network (LAN), as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for searching one or more documents in a Local Area Network (LAN). The computer program product includes a computer usable medium having a set program instructions comprising a program code for searching one or more documents in Local Area Network (LAN). The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

What is claimed is:

1. A system for searching one or more documents in a Local Area Network (LAN), the search being requested by one or more users, the one or more documents being at least one of a first set of documents stored on one or more pre-defined databases and a second set of documents stored on one or more software version control system (SVCS) databases, the system comprising:
a. a synchronization module configured for:
i. automatically synchronizing the one or more pre-defined databases comprising the first set of documents with a server at first pre-defined intervals of time;
ii. automatically synchronizing the one or more SVCS databases with the server at second pre-defined intervals of time;
b. a link module configured for:
i. connecting at least one user with the server in response to a request sent by the at least one user;
ii. receiving a search query from the at least one user; and
c. a search engine configured for receiving the search query from the link module and searching the synchronized one or more documents stored on the server.

2. The system according to claim 1, wherein the first set of documents are stored by the at least one user.

3. The system according to claim 2, wherein the first set of documents comprises one or more emails.

4. The system according to claim 3, wherein the at least one user stores the one or more emails at the one or more pre-defined databases by categorizing the one or more emails in one or more pre-defined categories and tagging the at least one email with at least one category.

5. The system according to claim 1, wherein the link module is further configured for receiving at least one of at least one message and one or more results in response to the search query from the search engine.

6. The system according to claim 5, wherein the link module is further configured for displaying the at least one of the at least one message and the one or more results.

7. The system according to claim 1, wherein the link module comprises an authentication module configured for authenticating the at least one user with the server based on a pre-defined list of authorized users.

8. The system according to claim 7, wherein the link module further comprises a list module configured for storing the pre-defined list of authorized users.

9. The system according to claim 1, wherein the synchronizing module is further configured for synchronizing a latest version of the second set of documents with the server.

10. The system according to claim 9, wherein the synchronizing module is further configured for updating an existing version corresponding to the latest version of the corresponding second set of documents, the updating being performed on the server.

11. The system according to claim 1, wherein the synchronization module is further configured for synchronizing at least one of the first set of documents and the second set of documents with the server based on one or more pre-defined authentication details.

12. The system according to claim 1, wherein the search engine is further configured for indexing the synchronized one or more documents based on the content.

13. The system according to claim 12, wherein the search engine indexes the synchronized one or more documents at third pre-defined intervals of time.

14. A method for searching one or more documents in a Local Area Network (LAN), the search being requested by one or more users, the one or more documents being at least one of a first set of documents stored on one or more pre-defined databases and a second set of documents stored on one or more software version control system (SVCS) databases, the method comprising:
a. synchronizing the one or more pre-defined databases comprising the first set of documents with a server at first pre-defined intervals of time;
b. synchronizing the one or more SVCS databases with the server at second pre-defined intervals of time;
c. connecting at least one user with the server in response to a request sent by the at least one user;
d. receiving a search query from the at least one user; and
e. searching the synchronized one or more documents stored on the server based on the search query.

15. The method according to claim 14, wherein the first set of documents are stored by the at least one user.

16. The method according to claim 15, wherein the first set of documents comprises one or more emails.

17. The method according to claim 16, wherein the at least one user stores the one or more emails at the one or more pre-defined databases by categorizing the one or more emails in one or more pre-defined categories and tagging the at least one email with at least one category.

18. The method according to claim 14 further comprising displaying at least one of at least one message and one or more results in response to the search query.

19. The method according to claim 14 further comprising authenticating the at least one user with the server, the at least one user being authenticated with the server based on a pre-defined list of authorized users.

20. The method according to claim 14 further comprising synchronizing latest version of the second set of documents with the server.

21. The method according to claim 20, wherein synchronizing further comprises updating the existing version corresponding to the latest version of the second set of documents, the updating being performed on the server.

22. The method according to claim 14 further comprising synchronizing the first set of documents and the second set of documents with the server based on one or more authentication details.

23. The method according to claim 14 further comprising indexing the one or more documents based on the content.

24. The method according to claim 23, wherein the one or more synchronized documents are indexed at third pre-defined intervals of time.

25. A computer program product for use with a stored program computer, the computer program product comprising a computer usable medium having a computer readable program code embodied therein for searching one or more documents in a Local Area Network (LAN), the search being requested by one or more users, the one or more documents being at least one of a first set of documents stored on one or more pre-defined databases and a second set of documents stored on one or more software version control system (SVCS) databases, the computer readable program code performing:
a. synchronizing the one or more pre-defined databases comprising the first set of documents with a server at first pre-defined intervals of time;
b. synchronizing the one or more SVCS databases with the server at second pre-defined intervals of time;
c. connecting at least one user with the server in response to a request sent by the at least one user;
d. receiving a search query from the at least one user; and
e. searching the synchronized one or more documents stored on the server based on the search query.

26. The computer program product of claim 25, wherein the first set of documents are stored by the at least one user.

27. The computer program product according to claim 26, wherein the first set of documents comprises one or more emails.

28. The computer program product according to claim 27, wherein the at least one user stores the one or more emails at the one or more pre-defined databases by categorizing the one or more emails in one or more pre-defined categories and tagging the at least one email with at least one category.

29. The computer program product according to claim 25, wherein the computer readable code further performs displaying at least one of at least one message and one or more results in response to the search query.

30. The computer program product according to claim 25, wherein the computer readable code further performs authenticating the at least one user with the server, the at least one user being authenticated with the server based on a pre-defined list of authorized users.

31. The computer program product according to claim 25, wherein the computer readable code further performs synchronizing latest version of the second set of documents with the server.

32. The computer program product according to claim 31, wherein the computer readable code further performs updating the existing version corresponding to the latest version of the second set of documents, the updating being performed on the server.

33. The computer program product according to claim 25, wherein the computer readable code further performs synchronizing the first set of documents and the second set of documents with the server based on one or more authentication details.

34. The computer program product according to claim 25, wherein the computer readable code further performs indexing the one or more documents based on the content.

35. The computer program product according to claim 25, wherein the one or more synchronized documents are indexed at third pre-defined intervals of time.
